(19) United States
(12) Patent Application Publication
(10) Pub. No.: US 2006/0084411 A1
(43) Pub. Date: Apr. 20, 2006

(54) Wireless infrastructure device for providing security in a wireless network

(75) Inventors: Yuan-Chang Lo, Austin, TX (US); Pratik M. Mehta, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/965,373

(22) Filed: Oct. 14, 2004

(51) Int. Cl. H04M 1/66; H04M 3/16; H04M 1/68; H04M 1/00; H04B 1/38

(52) U.S. Cl. 455/411; 455/558

(57) ABSTRACT

A method and wireless infrastructure device is provided. A wireless infrastructure device is configured so that the wireless infrastructure device includes security information, associated with providing security to a wireless network. The wireless infrastructure device is also provided with an interface, via which, the wireless infrastructure device is operable to output the security information, wherein the security information output is storable by a portable storage device.

### BACKGROUND

The present disclosure relates to providing security in a wireless network.

As the value and use of information continues to increase, individuals and businesses seek additional ways to process and store information. One option available to users is information handling systems. An information handling system (“IHS”) generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

A wireless infrastructure device (e.g., an access point, router, or gateway) for a wireless network (e.g., one of Institute of Electrical and Electronics Engineers (“IEEE”) 802.11 series networks) is capable of providing security for the wireless network. In one example, the wireless infrastructure device is configurable so that the wireless network includes a name (e.g., a Service Set Identifier (“SSID”)) and a security password (e.g., a key such as a Wired Equivalency Privacy (“WEP”) key) that is associated with the name. For users, configuring such wireless infrastructure device for providing security may be difficult, causing various problems for manufacturers and/or sellers of wireless infrastructure devices, such as increased cost of supporting customers.

What is needed is a method and wireless infrastructure device for providing security without the disadvantages discussed above.

### SUMMARY

A method and wireless infrastructure device is provided. A wireless infrastructure device is configured so that the wireless infrastructure device includes security information, associated with providing security to a wireless network. The wireless infrastructure device is also provided with an interface, via which, the wireless infrastructure device is operable to output the security information, wherein the security information output is storable by a portable storage device.

### BRIEF DESCRIPTION OF THE DRAWINGS

FIG. 1 is a block diagram of a system, indicated generally at 100 according to the illustrative embodiment.

FIG. 2 is a block diagram of an IHS that is a representative type of one of the wireless devices of FIG. 1.

FIG. 3A is a block diagram of a wireless device that is representative of one of the wireless devices of FIG. 1.

FIG. 3B is a block diagram of the wireless infrastructure device of FIG. 1.

FIG. 4 is a block diagram of various examples of the portable storage device of FIG. 3A.

FIG. 5 is a flow chart illustrating the operations associated with configuring a wireless network for providing security according to an embodiment.

FIG. 6 is a flow chart illustrating the operations associated with configuring a wireless network for providing security according to an embodiment.

FIG. 7 is a flow chart illustrating the operations associated with configuring a wireless network for providing security according to an embodiment.

FIG. 8 is a state diagram illustrating the states of the wireless infrastructure device of FIG. 1.

### DETAILED DESCRIPTION

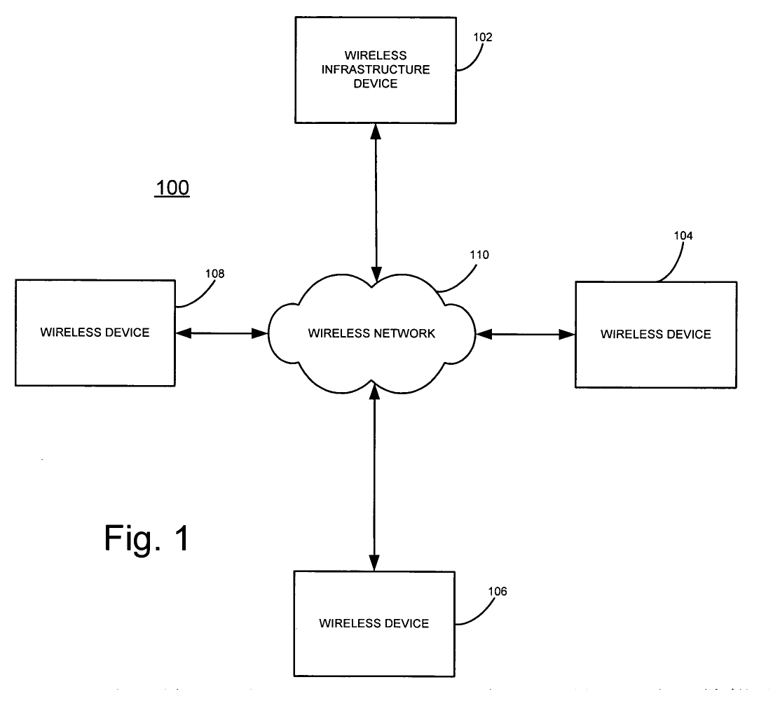

FIG. 1 is a block diagram of a system, indicated generally at 100 according to the illustrative embodiment. The system 100 includes a wireless infrastructure device (e.g., a wireless network access point, router, gateway, or a bridge) 102, wireless devices (e.g., IHSs with wireless network interfaces and other suitable devices, such as a printer, with a wireless network interface) 104, 106, and 108. The system 100 also includes a wireless network (e.g., network based on Institute of Electrical and Electronics Engineers (“IEEE”) 802.11 standard) 110. In one example, the wireless infrastructure device 102 forms the wireless network 110's infrastructure. Accordingly, in such example, each of the wireless devices 104, 106, and 108 communicates with each other, and the wireless network 110 via the wireless infrastructure device 102.

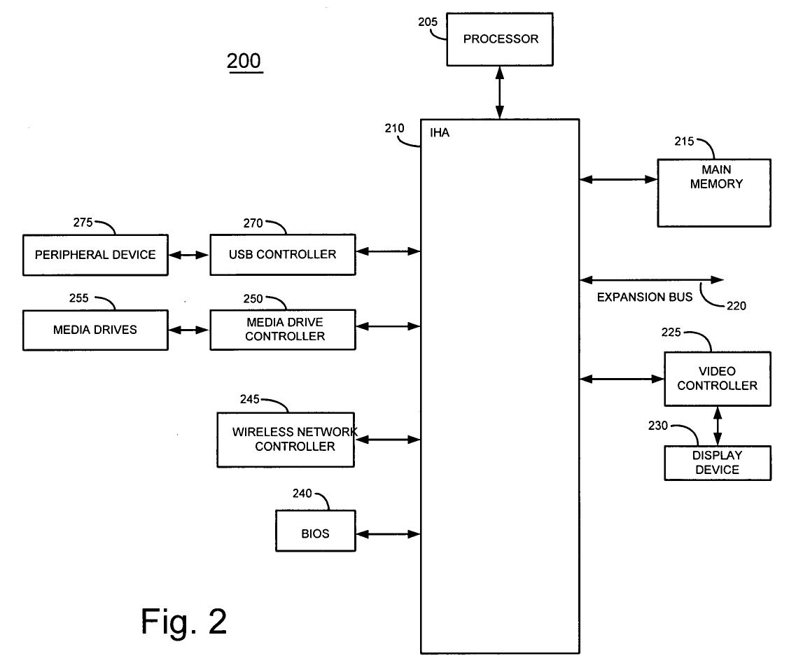

FIG. 2 is a block diagram of an IHS that is a representative type of one of the wireless devices 104, 106, or 108. For purposes of this disclosure, an IHS includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. Examples of an IHS include, personal computer (“PC”), a network storage device, personal digital assistant (“PDA”), or any other suitable device with variations in size, shape, performance, functionality, and price. An IHS also includes other components such as, random access memory (“RAM”), one or more processing resources (e.g., central processing unit (“CPU”)), hardware or software control logic, read only memory (“ROM”), other types of memory, one or more disk drives, one or more network interfaces, one or more input/output devices and/or one or more buses.

The IHS 200 includes a processor 205 (e.g., an Intel Pentium series processor). An Intel Hub Architecture (IHA) chipset 210 provides the IHS 200 with graphics/memory controller hub functions and I/O functions. More specifically, the IHA chipset 210 acts as a host controller which communicates with a video controller 225 coupled thereto. A display device 230 is coupled to the video controller 225.

The chipset 210 further acts as a controller for main memory 215 which is coupled thereto. The chipset 210 also acts as an input/output (“I/O”) controller hub (ICH) which performs I/O functions. A USB controller 270 is coupled to chipset 210 so that devices such as a print device 275 can be connected to the chipset 110 and the processor 205. A system basic input-output system (“BIOS”) 240 is coupled to chipset 210 as shown. The BIOS 240 is stored in CMOS or FLASH memory so that it is nonvolatile.

A wireless network controller 245 is coupled to the chipset 210 to facilitate connection of the IHS 200 to other IHSs and/or devices via a wireless network (e.g., the wireless network 110). A media driver controller 250 is coupled to chipset 210 so that devices such as media drives 255 can be connected to the chipset 210 and the processor 205. Examples of the media devices 255 capable of being coupled to the media controller 250 include CD-ROM drives, DVD drives, hard disk drives and other fixed or removable media drives. An expansion bus 220, such as a PCI bus, PCI Express bus, serial advanced technology attachment (“SATA”) bus or other bus is coupled to the chipset 110 as shown. The expansion bus 220 includes one or more expansion slots (not shown) for receiving expansion cards which provide the IHS 200 with additional functionality.

Referring again to FIG. 1, the wireless infrastructure device 102 is capable of providing security in the wireless network 110. In one example, the wireless infrastructure device 102 is operable so that in response to an instruction (e.g., a user command such as pressing a “reset” button of the wireless infrastructure device 102), the wireless infrastructure device 102 determines (e.g., randomly determines) configuration (e.g., security) information associated with the wireless network 110. Examples of such security information include a Service Set Identifier (“SSID”) and a security password or a key (e.g., a Wired Equivalency Privacy (“WEP”) “key” or a Wi-Fi Protected Access Pre-Shared Key (WPA PSK)) that is associated with the SSID (e.g., wireless network name). Accordingly, in response to receiving a request from a wireless device to communicate with the wireless network, the wireless infrastructure device 102 uses the security information for securing (e.g., via encrypting and/or decrypting) such communication. If the security information stored by the wireless device is valid (e.g., is equal to the security key stored by the wireless infrastructure device 102) for the wireless network, the wireless device is capable of connecting to the wireless network.

As discussed above, each of the wireless devices 104, 106, and 108 uses valid SSID and a security key to connect to a wireless network that is secure (e.g., wireless infrastructure device has its security feature enabled). Each of the wireless devices 104,106, and 108 includes an interface (e.g., a port or a slot) for coupling a portable storage device (e.g., a USB storage device or other suitable storage media such as a Compact Flash card or a Smart Media card) so that it is operable to be configured with a valid SSID and/or a security key. In at least one other embodiment, the each of the wireless devices 104,106, and 108 includes a network interface or another type of interface (e.g., a infrared communications interface) for receiving a valid SSID and/or a security key.

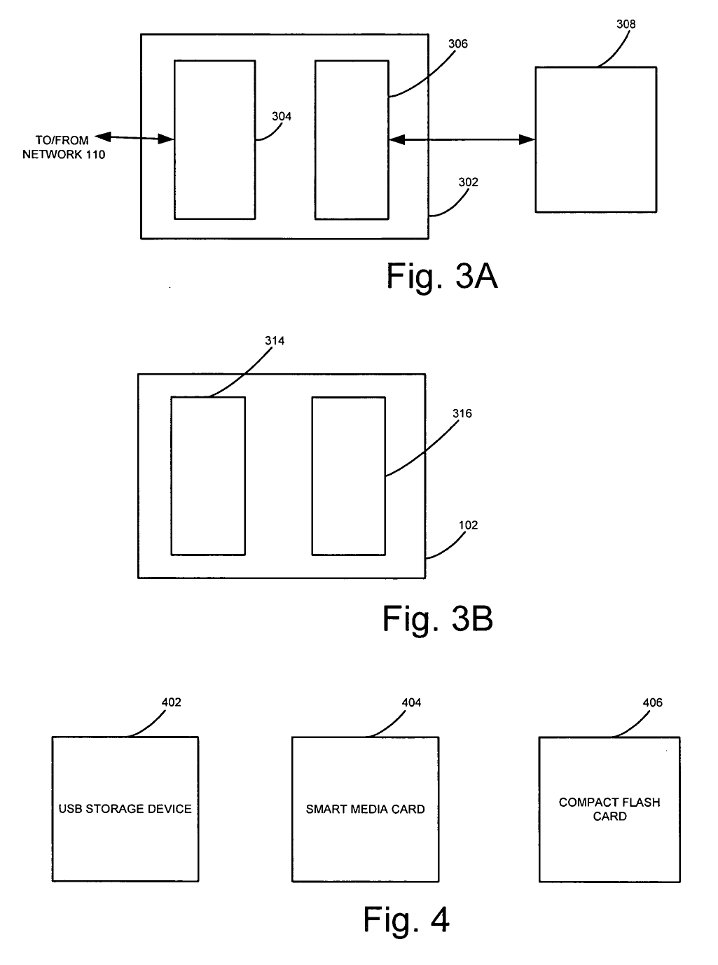

Accordingly, FIG. 3A is a block diagram of a wireless device, indicated at 302, that is representative of one of the wireless devices 104,106, and 108 of FIG. 1. The wireless device 302 includes a wireless network controller (e.g., the network controller 245 of FIG. 2) so that the wireless device 302 is capable of communicating with a wireless network (e.g., the wireless network 110) and other wireless devices that are coupled to the wireless network. Also, the wireless device 302 includes a portable storage interface (e.g., a USB port, a Compact Flash card slot, a Smart Media card slot) 306. Via the interface 306, a user is able to couple (e.g., “plug”) a portable storage device 308 to the wireless device 302. The portable storage device 308 is capable of storing security information, such as a SSID and a security key, for a wireless network.

While the portable storage device 308 is coupled to the wireless device 302, the wireless device 302 receives the SSID and the security key that is stored by the portable storage device 308. In one embodiment, after receiving the SSID and the security key, the wireless device 302 stores them in its storage device. Accordingly, when connecting to a wireless network, the wireless device 302 outputs the SSID and the security key that is stored in its storage device. In an alternative embodiment, the wireless device 302 outputs the SSID and the security key that is stored in the portable storage device 308 when connecting to a wireless network.

FIG. 3B is a block diagram of the wireless infrastructure device 102 of FIG. 1. The wireless infrastructure device 102 includes a wired network controller (e.g., an Ethernet controller) 314. The wireless infrastructure device 102 also includes a portable storage interface 316 that is substantially similar to the portable storage interface 306 (discussed in more detail above in connection with FIG. 3A).

FIG. 4 is a block diagram of various examples of the portable storage device 308. The examples shown in FIG. 4 are illustrative and not exhaustive of the types of portable storage device 308.

In a first example, the portable storage device 308 is a USB storage device 402, which is capable of being coupled to a USB port of an IHS (e.g., the IHS 200 of FIG. 2). In a second example, the portable storage device 308 is a Smart Media card 404. In a third example, the portable storage device 308 is a Compact Flash card 406.

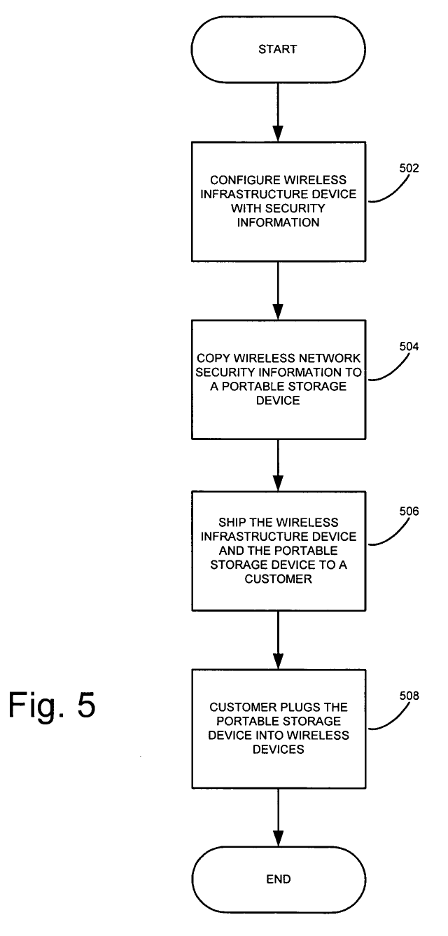

FIG. 5 is a flow chart illustrating the operations associated with configuring a wireless network for providing security according to an embodiment. The operation begins at a step 502, where a manufacturer or a reseller of a wireless infrastructure device configures (e.g., by enabling security feature of the device) the device with security information. In one example, the wireless infrastructure device determines (e.g., generates) a new SSID and a security key in response to a reset command from a user. Also, in the example, such SSID and security key are generated randomly. In one embodiment, the wireless infrastructure device is capable of generating a random user password (e.g., administrator password) for administering the wireless infrastructure device. After the step 502, the operation continues to a step 504.

At the step 504, the manufacturer or the seller copies the wireless security information that is stored by the wireless infrastructure device onto a portable storage device (e.g., the portable storage device 308). After the step 504, the operation continues to a step 506, where the manufacturer/seller “ships” the wireless infrastructure device and the associated portable storage device to a customer (e.g., a user). After the step 506, the operation continues to a step 508.

At the step 508, the customer couples (e.g., “plugs”) the portable storage device to one or more wireless devices that customer wishes to configure for access to a wireless network that is formed by the wireless infrastructure device. In this situation, the wireless network that is formed using the wireless infrastructure device is “secure” because the manufacturer/seller, in the step 502, has enabled the security feature of the wireless infrastructure device. By plugging in the portable storage device into the wireless devices, the customer is able to configure such wireless devices so that the wireless devices are able to connect to the wireless network using the security information stored by the portable storage device.

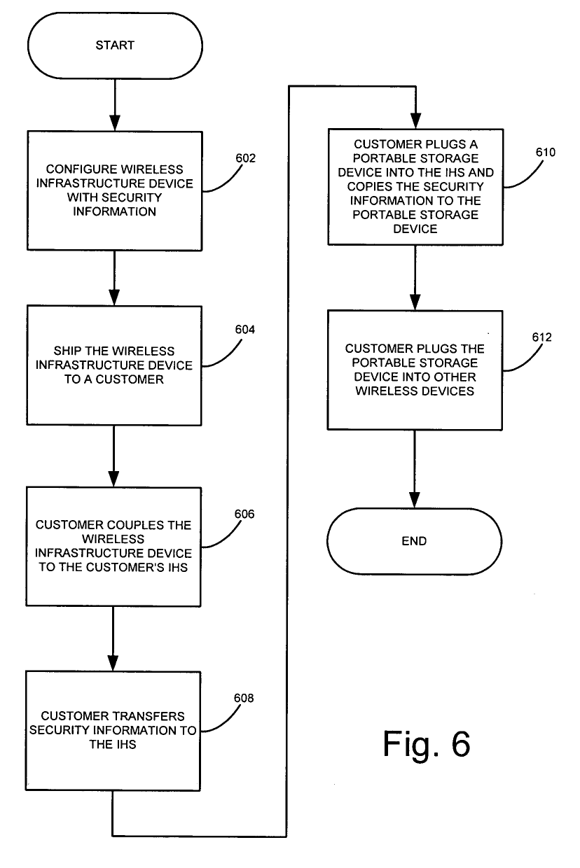

FIG. 6 is a flow chart illustrating the operations associated with configuring a wireless network for providing security according to an embodiment. Similar to the first embodiment discussed in connection with FIG. 5, the operation begins at a step 602, where a manufacturer/seller configures a wireless infrastructure device with configuration information (e.g., security information). After the step 602, the operation continues to a step 604.

At the step 604, the manufacturer/seller ships the wireless infrastructure device to a customer. After the step 604, the operation continues to a step 606, where the customer couples the wireless infrastructure device to the customer's IHS via a suitable interface such as a wired network controller interface (e.g., the network controller 314) or a infrared communications interface. After the step 606, the operation continues to a step 608.

At the step 608, the customer operates the IHS and the wireless infrastructure device, so that the security information stored by the wireless infrastructure device is output (e.g., transferred) to the IHS. In one example, in association with such security information, the IHS executes a process (e.g., a computer application such as a “setup wizard”). The IHS receives such security information and stores the information in its storage device. After the step 608, the operation continues to a step 610.

At the step 610, the customer couples a portable storage device to the IHS, and operates the IHS and the portable storage device so that the security information stored by the IHS's storage device is copied to the portable storage device. After the step 610, the operation continues to a step 612, where the customer couples the portable storage device to one or more other wireless devices for configuration of such devices.

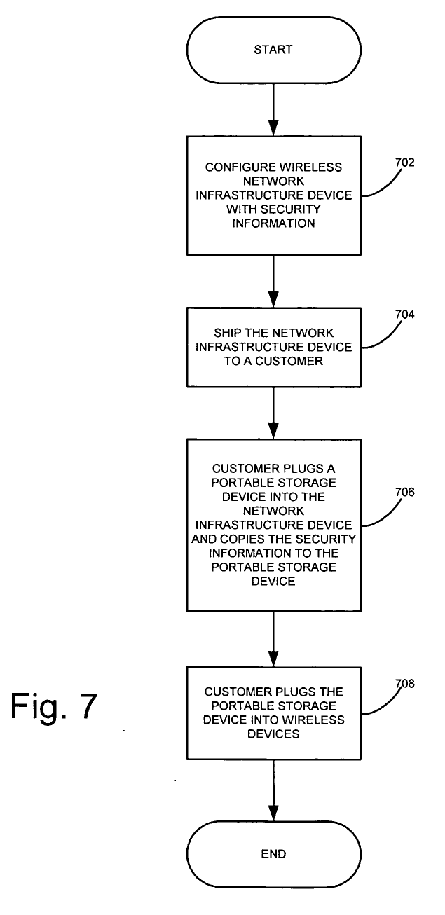

FIG. 7 is a flow chart illustrating the operations associated with configuring a wireless network for providing security according to an embodiment. Similar to the first and the second embodiments discussed above respectively in connection with FIGS. 5 and 6, the operation begins at a step 702, where a manufacturer/seller configures a wireless infrastructure device with security information. After the step 702, the operation continues to a step 704.

At the step 704, the manufacturer/seller ships the now configured wireless infrastructure device to a customer. After the step 704, the operation continues to a step 706.

At the step 706, the customer couples a portable storage device to the wireless infrastructure device via the wireless infrastructure device's portable storage interface (e.g., the portable storage interface 316). Also, at the step 706, the customer operates the wireless infrastructure device and the portable storage device so that the security information stored by the wireless infrastructure device is copied to the portable storage device. After the step 706, the operation continues to a step 708, where the customer couples the portable storage device to one or more wireless devices for configuration of such devices.

In the embodiments discussed above in connection with FIGS. 5, 6, and 7, the wireless infrastructure device is operable to modify (e.g., regenerate) security information associated with a wireless network. In one example, a customer may wish to modify security information associated with a wireless network because there has been a security breach (e.g., an unauthorized person has obtained the security information). In such situation, the customer is able to “reset” the security information, for example, by pressing a button on the wireless infrastructure device. In response to such reset command from the customer, the wireless infrastructure device randomly generates new security information that is different from the previous security information. In one example, the wireless infrastructure device also generates a new password (e.g., an administrator password) for the wireless infrastructure device. After the wireless infrastructure device generates the new security information, the user is capable of configuring one or more wireless devices using a portable storage device as discussed above in connection with FIGS. 6 and 7.

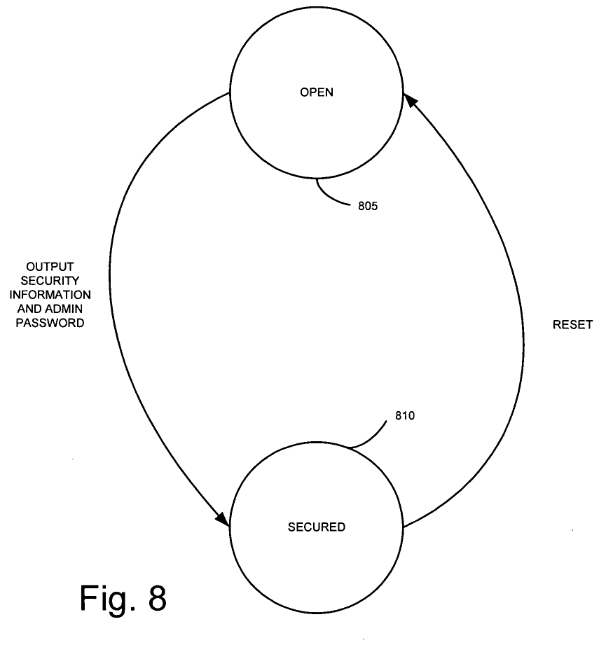

In one embodiment, the wireless infrastructure device is capable of operating in one of two “states”, and is capable of switching between the two states in response to the wireless infrastructure device outputting security information (e.g., as discussed in connection with the step 608 of FIG. 6) and/or receiving a reset command. Accordingly, FIG. 8 is a state diagram illustrating the states of the wireless infrastructure device.

According to the state diagram, the wireless infrastructure device includes a first state 805 (e.g., an “open” state) and a second state 810 (e.g., a “secured” state). In the open state 805, the wireless infrastructure device is capable of outputting security information (e.g., as discussed in connection with the step 608 of FIG. 6) so that such information is usable to configure wireless devices. In one example, the wireless infrastructure device is also capable of outputting its password.

In response to the wireless infrastructure device actually outputting such security information and/or password, the wireless infrastructure device enters the secured state 810. While in the secured state 810, the wireless infrastructure device is incapable of (e.g., prevented from) outputting security information and/or its password. In this way, after the wireless infrastructure device has outputted security information and/or its password, the wireless infrastructure device prevents an unauthorized user from obtaining the security information and/or the password. In one example, a manufacturer or a seller ships the wireless infrastructure device to a user in the secured state 810.

In response to a reset command, the wireless infrastructure device enters the open state 805, so that the wireless infrastructure device is now capable outputting security information and/or its password as discussed above. Accordingly, if the wireless infrastructure device is capable of resetting only in response a user pressing a reset button located on the wireless infrastructure device, only a user who is in its physical possession is capable of operating the wireless infrastructure device, so that it enters the open state 810. In this way, the wireless infrastructure device decreases the likelihood that the security information and its password are obtainable by an unauthorized user.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method comprising:
configuring a wireless infrastructure device so that the wireless infrastructure device includes security information, associated with providing security to a wireless network; and
providing the wireless infrastructure device with an interface, via which, the wireless infrastructure device is operable to output the security information, wherein the security information output is storable by a portable storage device.

2. The method of claim 1, and comprising:
coupling the portable storage device to a wireless device for configuring the wireless device.

3. The method of claim 1, and comprising:
storing the security information on the portable storage device; and shipping the wireless device and the portable storage device to a customer.

4. The method of claim 1, wherein the configuring includes:
generating the security information randomly.

5. The method of claim 1, wherein the interface is a wired network interface.

6. The method of claim 5, wherein the interface is an Ethernet interface.

7. The method of claim 1, wherein the interface is a portable storage device interface.

8. The method of claim 1, wherein the portable storage device is a Universal Serial Bus (“USB”) device.

9. The method of claim 1, wherein the portable storage device is a Smart Media card.

10. The method of claim 1, wherein the portable storage device is a Compact Flash card.

11. The method of claim 1, wherein configuring the wireless infrastructure device includes configuring by resetting the wireless infrastructure device.

12. The method of claim 1, wherein the portable storage device is provided by a customer.

13. The method of claim 1, wherein the wireless infrastructure device is a wireless router.

14. The method of claim 1, wherein the wireless infrastructure device is a wireless access point.

15. The method of claim 1, wherein the wireless infrastructure device is a wireless bridge.

16. The method of claim 1, wherein the wireless infrastructure device, in response to outputting the security information, becomes incapable of outputting the security information.

17. The method of claim 16, wherein the wireless infrastructure device, in response to a reset command, generates new security information and becomes capable of outputting the new security information.

18. A wireless infrastructure device comprising:
an interface for:
outputting security information associated with providing security to a wireless network, wherein the security information is storable by a portable storage device.

19. The device of claim 18, wherein the interface is a wired network interface.

20. The device of claim 19, wherein the interface is an Ethernet interface.

21. The device of claim 18, wherein the interface is a portable storage device interface.

22. The device of claim 18, wherein the storage device is coupled to a wireless device for configuring the wireless device.

23. The device of claim 18, wherein the storage device is a Universal Serial Bus (“USB”) device.

24. The device of claim 18, wherein the storage device is a Smart Media card.

25. The device of claim 18, wherein the storage device is a Compact Flash card.
